(19) United States
(12) Patent Application Publication
(10) Pub. No.: US 2003/0225864 A1
(43) Pub. Date: Dec. 4, 2003

(54) Host-based automatic negotiation of an internet protocol address for a network connected device

(76) Inventors: Samuel W. Gardiner, Lexington, KY (US); Duane E. Norris, Lexington, KY (US); Thomas E. Samples, Lexington, KY (US); James L. Bush III, Lexington, KY (US); Zachary N. Fister, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/159,070

(22) Filed: May 31, 2002

(51) Int. Cl. G06F 15/173

(52) U.S. Cl. 709/220; 709/223

(57) ABSTRACT

A host computer connected to a network serves as a proxy IP address negotiator for another device connected to the network. The host computer constructs and sends a first network packet for communicating with an IP address server connected to the network. The IP address server responds to the host computer with a second network packet including a first IP address. The host computer retrieves the first IP address from the second network packet, and sends the first IP address to the device for adoption by the device as the device IP address.

### BACKGROUND OF THE INVENTION

1. Field of the Invention

The present invention relates to a method of negotiating Internet Protocol (IP) addresses, and, more particularly, to automatically negotiating an IP address for a non-host network-connected device, such as a peripheral device connected to the network via networking hardware, wherein the negotiation is effected by a network-connected host device. Such automatic negotiation can include, for example, the automatic assignment of an IP address for use by the non-host network-connected device.

2. Description of the Related Art

It is known for a peripheral device, such as a printer, to be connected to a network, such as an Ethernet Local Area Network (LAN) operating with TCP/IP as a network protocol, in order to allow a number of network connected appliances, such as servers, computers or hosts, to each have access to the shared peripheral device, all devices connected to the network must adhere to a common standard for transporting data on the network. For example, DIX or Institute of Electrical and Electronic Engineers (IEEE) 802.3 define the standard for Ethernet. In adhering to the Ethernet standard, each device connected to the network will have a universally administered address (UAA). Also, in order to function over the network, the shared peripheral device connected to the network must have an Internet Protocol (IP) address that the network connected appliances use to direct communications to the shared peripheral device.

In smaller TCP/IP networks, for example, the host software may automatically configure a printer's IP address in the address ranges predefined for Internet Connection Sharing (ICS) (192.168.XXX.XXX) or Universal Plug and Play (UpnP) (169.254.XXX.XXX) networks. Manual assignment of the printer IP address is required in other types of networks. Medium to large networks typically use Dynamic Host Configuration Protocol (DHCP) to automatically configure computing devices on the network.

DHCP is a protocol for assigning dynamic IP addresses to devices on a TCP/IP network. DHCP is well defined by RFC 2131, a document issued by the Internet Engineering Task Force (IETF). With dynamic addressing, a device can have a different IP address every time it connects to the network. In some systems, the device's IP address can even change while it is still connected. DHCP also supports a mix of static and dynamic IP addresses. DHCP simplifies network administration because software keeps track of IP addresses rather than requiring an administrator to manage the task. This means that, for example, a new computer can be added to a network without the additional task of manually assigning a unique IP address to the new computer.

Through DHCP, a device connected to a network requests an IP address from a DHCP server that also is connected to the network. The DHCP server can then assign an IP address to the device for a specified lease period. The device is then responsible for renewing that lease if it wishes to continue using that IP address after the expiration of the lease. The DHCP protocol requires considerable processing power to create DHCP network packets, choose offers from the DHCP servers, and keep track of lease time periods.

Typically, DHCP only allows a computing device to negotiate an address for itself This is because the DHCP server links its allocated IP addresses to the Universally Administered Address (UAA) of the negotiating device. Therefore, typically one network-connected device cannot obtain an IP address from a DHCP server for another network-connected device. However, DHCP has the capability to work across routers, using a field for the IP address of a “relay agent”. Typically a router, as it forwards the packet to a separate subnet, will insert its IP address in that field, which lets the DHCP server know the DHCP negotiation packets are not coming directly from the negotiating host, but rather, from the router.

Alternative methods exist to find a free IP address in DHCP environments, but they are problematic. For instance, a host could find an unused IP address on the subnet using the Internet Control Message Protocol (ICMP) ping command. Different addresses are “pinged”, and if no response is received, it's assumed the address is unused, even though a device that uses that address might simply be turned off at the time the ping was sent. This creates a situation where IP addresses could be duplicated, which can cause communication problems and seriously degrade network performance.

A reduced feature network adapter can be used to connect a printer to a network, such as an Ethernet LAN. Such reduced feature network adapters possess minimal hardware and processing capability. As such, the cost of adding networking capability to printers is greatly reduced. In order to keep the cost of the reduced feature network adapter low, some features that facilitate network connectivity and that save time and effort for the network user are not provided. Such features not currently available in association with a reduced feature network adapter include, for example, the automatic assignment of IP addresses using DHCP, i.e., using DHCP to obtain and use an IP address. In lieu of automatic assignment of IP addresses, the reduced feature network adapter utilizes a proprietary networking protocol to assign an IP address in specific networking environments, but requires the user to manually assign IP addresses in all other cases.

What is needed in the art is a method for automatically negotiating an IP address for a non-host network-connected device, such as a peripheral device connected to the network via networking hardware, wherein the negotiation is conducted by a network-connected host.

### SUMMARY OF THE INVENTION

In one embodiment, the present invention provides a method that allows automatic negotiation of IP addresses for a non-host network-connected device, such as a peripheral device connected to a network via networking hardware, wherein the negotiation of IP addresses is conducted by a network-connected host, such as a personal computer.

In one form thereof, the present invention relates to a method for negotiating a device IP address for a device connected to a network. The method includes the steps of configuring a host computer connected to the network to serve as a proxy IP address negotiator; the host computer constructing a first network packet for communicating with an IP address server connected to the network; the host computer sending the first network packet over the network; the IP address server responding to the host computer with a second network packet including a first IP address; the host computer retrieving the first IP address from the second network packet; and the host computer sending the first IP address to the device for adoption by the device as the device IP address.

In another form thereof, the present invention relates to a networked system. The networked system includes a network, a device connected to the network, an IP address server connected to the network and a host connected to the network. The host has a host Internet Protocol (IP) address. The host negotiates a device IP address for the device by executing computer instructions for performing the steps of determining a universally administered address (UAA) of the device; constructing a Dynamic Host Configuration Protocol (DHCP) discover packet, the host inserting the host IP address in a relay agent field of the DHCP discover packet, and including the UAA of the device; sending the DHCP discover packet over the network; retrieving a first IP address from the IP server; and sending the first IP address to the device for adoption by the device as the device IP address.

In still another form thereof, the present invention relates to a non-volatile memory configured with computer program instructions for loading on a host computer. The computer program instructions are adapted to configure the host computer to serve as a proxy IP address negotiator for negotiating a device IP address for a device connected to the network other than the host computer.

In still another form thereof, the present invention relates, in a system including a device connected to a network, an IP address server connected to the network and a host connected to the network, the host having a host Internet Protocol (IP) address, to a method for negotiating a device IP address for the device. The host performs the steps of determining a universally administered address (UAA) of the device; constructing a Dynamic Host Configuration Protocol (DHCP) discover packet by inserting the host IP address in a relay agent field of the DHCP discover packet, and by including the UAA of the device; sending the DHCP discover packet over the network; retrieving a first IP address from the IP address server; and sending the first IP address to the device for adoption by the device as the device IP address.

An advantage of certain embodiments of the present invention is that a networked device utilizing a reduced feature network adapter can benefit from DHCP IP address negotiation when a host serves as a proxy IP address negotiator to negotiate an IP address on behalf of the networked device.

Another advantage of certain embodiments of the present invention is that the low cost of networking hardware having reduced networking features can be preserved while allowing the networking hardware to benefit from automatic IP address negotiation.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram of an exemplary network system embodying the present invention; and

FIGS. 2A and 2B are flow charts which describe the automatic IP address negotiation aspects of one embodiment of the invention.

Corresponding reference characters indicate corresponding parts throughout the several views. The exemplification set out herein illustrates one exemplary embodiment of the invention, in one form, and such exemplification is not to be construed as limiting the scope of the invention in any manner.

### DETAILED DESCRIPTION OF THE INVENTION

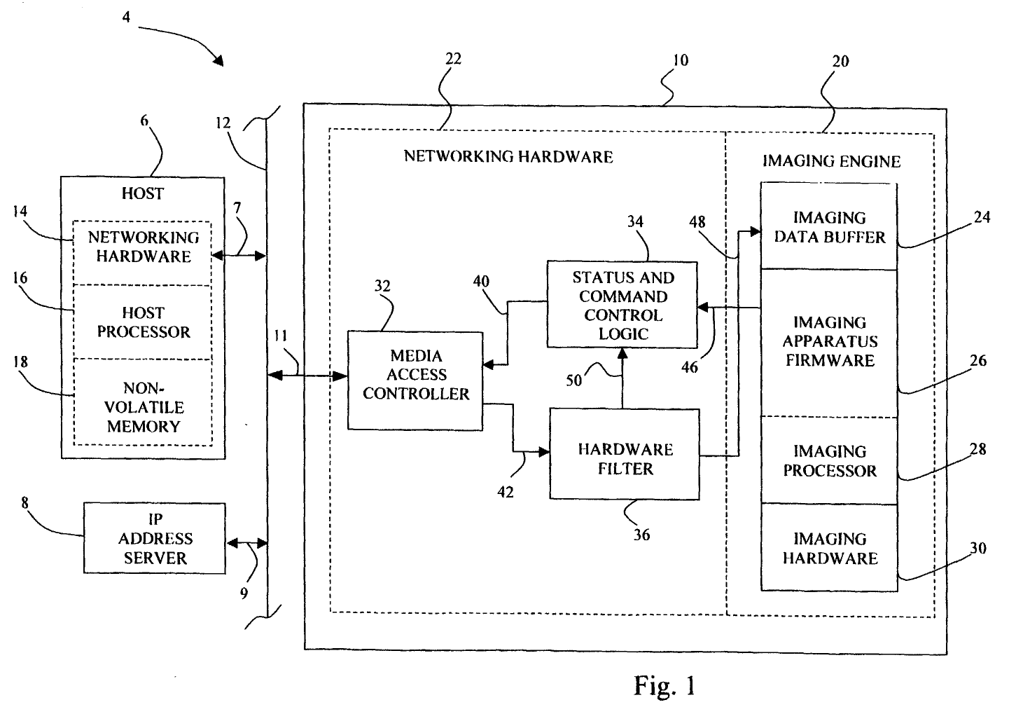

Referring now to the drawings, there is shown in FIG. 1 a network system 4 including a host 6, an IP Address server 8, an imaging apparatus 10 and a network 12, such as an Ethernet local area network (LAN). All devices connected to network 12 adhere to a common standard, e.g., Ethernet, for transporting data on network 12. In the present embodiment, host 6 will serve as a proxy IP address negotiator to negotiate an IP address for imaging apparatus 10.

Host 6, such as a personal computer, is communicatively coupled to network 12 via a bi-directional communications link 7. IP Address server 8, such as a DHCP server, is communicatively coupled to network 12 via a bi-directional communications link 9. Imaging apparatus 10, such as a printer, is connected to network 12 via a bi-directional communications link 11.

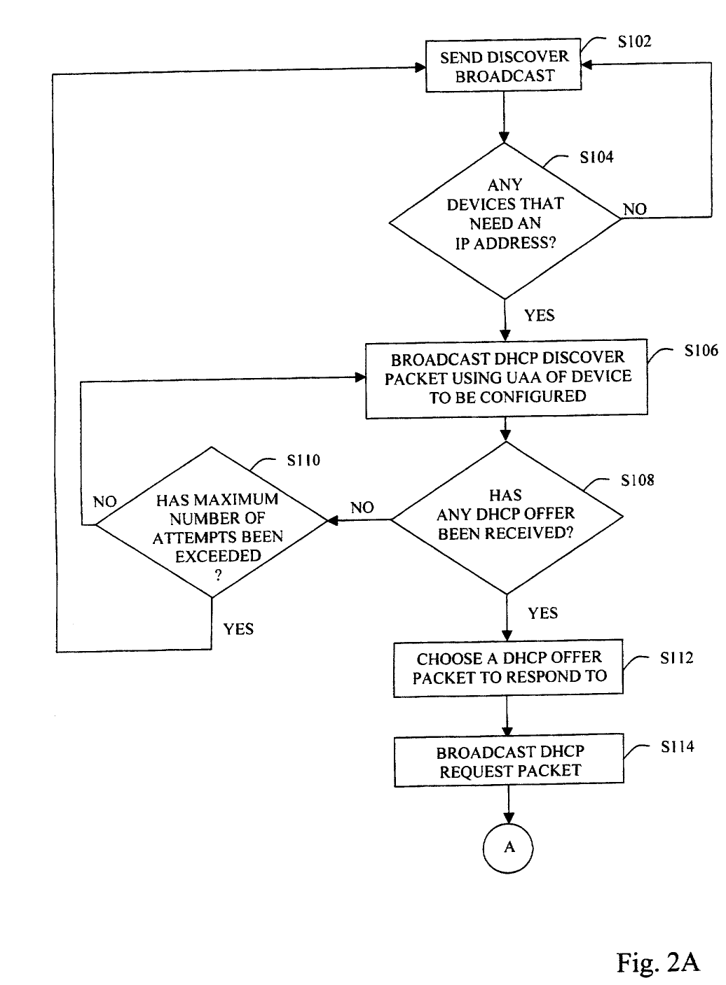

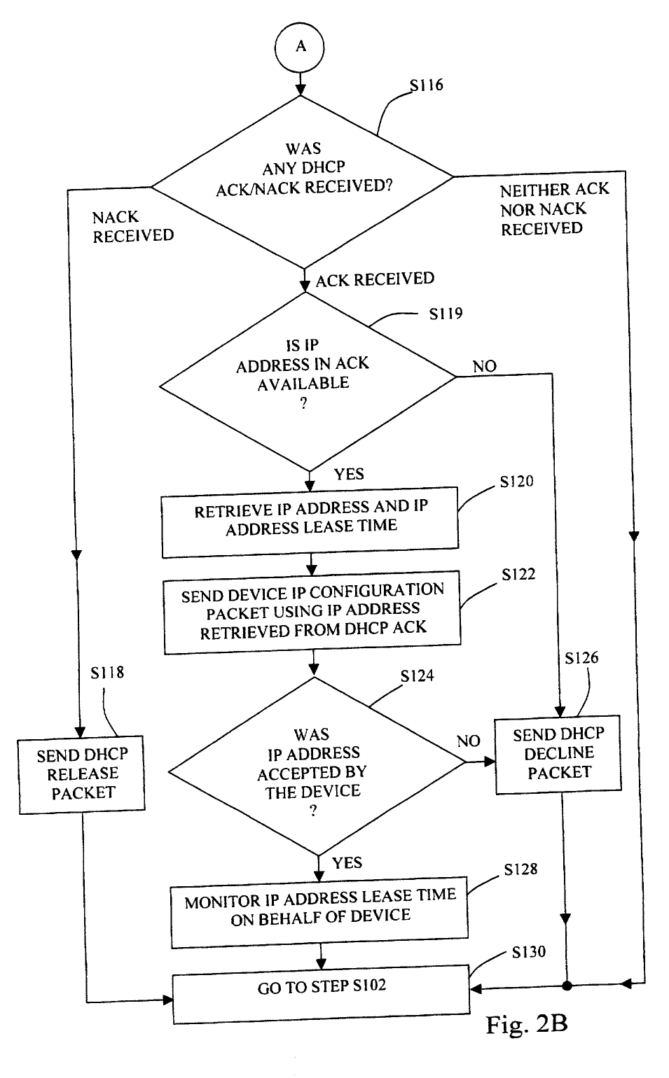

In the embodiment shown, host 6 is a personal computer that includes networking hardware 14, a host processor 16 and non-volatile memory 18, interconnected and communicating in a manner well known in the art. Networking hardware 14 is full-featured networking hardware, and is connected to network 12 via bi-directional communications link 7 to facilitate communications over specific types of networks, such as for example, Ethernet, and including communications with IP address server 8, such as a DHCP server. Host processor 16 includes a microprocessor and associated RAM and ROM. Non-volatile memory 18 may be, for example, one or more of a magnetic or optical data storage medium (read only or read/write) with an associated reader, read only memory (ROM), flash memory, or electrically erasable programmable ROM (EEPROM). Through software loaded in non-volatile memory 18, host processor 16 retrieves and executes computer program instructions that perform the functions depicted in FIGS. 2A and 2B, as discussed more fully below, to automatically negotiate on behalf of imaging apparatus 10 an IP address for use by imaging apparatus 10 and/or networking hardware 22. Thus, not only can host 6 automatically negotiate for itself its own IP address, but in accordance with the present invention, host 6 serves as a proxy IP address negotiator for imaging apparatus 10.

IP address server 8, when operating for example as a DHCP server, typically links its allocated IP addresses to the UAA (Universally Administered Address) of the negotiating device. Therefore, it is not straightforward for one computing device, such as host 6, to obtain an IP address from IP address server 8 for another device, such as imaging apparatus 10 or other networked hardware.

Imaging apparatus 10, which serves as a shared networking appliance, includes an imaging engine 20 communicatively coupled to networking hardware 22. Imaging engine 20 includes an imaging data buffer 24, imaging apparatus firmware 26, an imaging processor 28 and imaging hardware 30. Imaging data buffer 24 includes random access memory (RAM) used to temporarily store image data and associated imaging commands. Imaging apparatus firmware 26 includes non-volatile memory, such as for example read only memory (ROM), flash memory, or electrically erasable programmable ROM (EEPROM), and defines logic and processing functions executed by imaging processor 28. Imaging processor 28 includes a microprocessor and associated RAM and ROM. Imaging hardware 30 can be, for example, the hardware mechanisms of an ink jet printer or laser printer, which are well known in the art.

Networking hardware 22, which may be for example a reduced feature network adapter, includes a media access controller 32, status and command control logic 34 and a hardware filter 36. Media access controller 32 is connected to network 12 via bi-directional communications link 11 and facilitates communications over specific types of networks, such as, for example, Ethernet. Media access controller 32 also is connected to receive status information regarding imaging apparatus 10 from status and command control logic 34 via a communications path 40. Media access controller 32 is connected to provide data received from network 12 in the form of network packets to hardware filter 36 via a communications path 42. Status and command control logic 34 is connected to receive imaging apparatus status information from imaging apparatus firmware 26 via a communications path 46.

Hardware filter 36 is connected to provide received network packets including image data and associated imaging commands to imaging data buffer 24 via a data channel 48. Hardware filter 36 is connected to deliver instructions to status and command control logic 34 via command channel 50.

Data channel 48 is used to send print objects from a workstation host-based printing driver of host 6 to imaging apparatus 10 using a “payload” field in a frame of a imaging network packet, such as in a packet associated with a proprietary protocol having predefined commands. To minimize complexity and thus minimize cost of networking hardware 22, in one embodiment, hardware filter 36 only permits one workstation, such as host 6, to “own” data channel 48 at any given point in time. Any information destined for data channel 48 that does not originate from the host “owner” is immediately discarded by hardware filter 36.

Command channel 50 is used to signal the networking hardware 22 of command activity. Any host-based networking appliance can send commands via network packets to networking hardware 22 which are processed by media access controller 32 and hardware filter 36. Various command signals can be defined. For example, the signals “connect”, “close”, “terminate” and “status” can be defined as follows. “Connect” is a request to acquire data channel 48 with a desire to send data. “Close” is a request to release data channel 48. “Terminate” is a request to release data channel 48 and abort a print job. In this scenario, according to one embodiment of the present invention, only a host-based network appliance, such as host 6, that is the owner of data channel 48 can send a “close” command. “Status” is a request for printer status with no desire to send data. Networking hardware 22 will respond with a status response to a status request command destined for command channel 50 received from any user while imaging apparatus 10 is in an imaging state.

To facilitate printing, the print driver loaded in a workstation, such as host 6, creates host-based networking printer specific data packets in a format compliant with the predefined protocol and delivers the data packets in order and unaltered to a host-based networking printer, such as imaging apparatus 10. Workstation host-based networking print drivers are designed to cooperate in order to facilitate the “fair-sharing” of the host-based networking printer amongst a number of workstations. In adhering to the communication standard for network 12, each networked-connected device will have a universally administered address (UAA), which in the case of imaging apparatus 10 is a media access controller (MAC) address. Also, to communicate on TCP/IP networks, each network-connected device will have a unique IP address. Further adherence dictates that the host-based networking appliances will use these addresses to exchange basic units of data (frames) in networking packets. The addresses are used by networking hardware 14, for example, to deliver frames to an intended destination.

As a simplified example, and assuming that imaging apparatus 10 already has an IP address, communications is initiated by host 6 with imaging apparatus 10 via network 12 and communications links 7 and 11. Host 6 obtains ownership of data channel 48 and provides image data and associated imaging commands in the form of network packets to imaging apparatus 10, which is processed and stored in imaging data buffer 24. During image formation, imaging processor 28 executes imaging instructions stored in imaging apparatus firmware 26 to retrieve the image data and associated imaging commands that are stored in imaging data buffer 24. Imaging processor 28 then processes the retrieved image data and associated imaging commands to generate signals to control the operation of imaging hardware 30 to form a printed image.

It is known that in some networking environments the IP address of a network-connected device can be statically assigned, or may be dynamically assigned. However, in accordance with one embodiment of the present invention, in order for imaging apparatus 10, or networking hardware 22, to utilize dynamic IP address assignment, such as by utilizing DHCP, host 6 serves as a proxy IP address negotiator for imaging apparatus 10, and as such host 6 is capable of handling the associated automatic IP address negotiation network packets, such as DHCP packets. In general, with one embodiment of the present invention, by processing automatic IP address negotiation network packets by host software executing on host processor 16, while using networking hardware 22 to perform many of the rudimentary networking protocol functions, such as for example those associated with any proprietary protocol, the cost of providing an automatic IP address negotiation capability, such as through DHCP, to imaging apparatus 10 is minimized.

A method according to one embodiment of the present invention is described in further detail below with reference to FIGS. 2A and 2B. To simplify the discussion, the method that follows will be described with respect to a DHCP environment, however, those skilled in the art will recognize that the principles of the invention may be applied to other automatic IP address negotiation protocols without departing from the spirit of the invention.

In the present embodiment, the method of the present invention is implemented through computer program instructions loaded in non-volatile memory 18 and executed by host processor 16, which controls interaction between host 6 and imaging apparatus 10 and controls interaction between host 6 and IP address server 8.

At step S102, host 6 sends a proprietary discover broadcast over network 12 to determine, at step S104, whether any device connected to network 12 that can interpret the proprietary discover broadcast packet does not have a valid IP address.

At step S104, if the decision is NO, then the process returns to step S102. If the decision is YES, then the process proceeds to step S106.

At step S106, host 6 broadcasts a DHCP discover packet using the UAA of the device for which an IP address is desired. In this example, it will be assumed that the device for which an IP address is desired is imaging apparatus 10. More specifically, host 6 inserts the IP address of host 6 into the “relay agent” field of the DHCP discover packet, and includes the UAA of imaging apparatus 10 in the DHCP discover packet. In this example, the UAA will be the media access controller (MAC) address of networking hardware 22 of imaging apparatus 10. In this way, the host 6 informs any DHCP server on network 12 of a client in need of an IP address. In this example, it will be assumed that IP address sever 8 is a DHCP server. IP address server 8 assumes that host 6 is a router device and will send DHCP negotiation packets to host 6, and allocate an IP address for networking hardware 22, and as such, for imaging apparatus 10.

At step S108, host 6 determines whether any DHCP offer has been received.

If the result of step S108 is NO, then the process proceeds to step S110 to determine whether the maximum number of attempts, for example five, have been exceeded. If at step S110 the determination is NO, then the process returns to step S106 to resend the broadcasted DHCP discover packet. If at step S110 the determination is YES, then an error condition is declared and the process returns to the beginning at step S102.

If the result of step S108 is YES, the process proceeds to step S112.

At step S112, host 6 chooses one of the DHCP offer packets, assuming multiple DHCP offer packets were received. In this example, it is assumed that host 6 has selected to respond to an offer packet from IP address server 8. Such a selection can be, for example, a random selection.

At step S114, host 6 constructs and broadcasts a DHCP request packet. The process then proceeds to step S116 (FIG. 2B).

At step S116, host 6 determines whether any DHCP ACK or NACK packets were received.

If, at step S116, at least one NACK packet was received and no ACK packet was received, then at step S118, host 6 constructs a DHCP release packet. Host 6 then sends the DHCP release packet over network 12. Then, following step S118, the process proceeds to step S130, and returns to step S102 to again start the automatic IP address negotiation routine.

If, at step S116, neither an ACK nor a NACK was received, an error condition is declared, and the process proceeds to step S130, which in turn directs the process to return to step S102.

If, at step S116, it is determined that an ACK packet was received, then the process proceeds to step S119.

At step S119, it is determined whether the IP address in the ACK packet is available. In particular, at step S119, host 6 constructs an Address Resolution Protocol (ARP) request packet using the IP address specified in the ACK packet. Host 6 then sends the ARP request packet over network 12. Host 6 then determines whether any ARP reply packet has been received. If an ARP reply packet was received, then host 6 judges that the IP address in the ACK packet is not available. If no ARP reply packet was received, then host 6 judges that the IP address in the ACK packet is available.

Thus, if the decision at step S119 is NO, then the process proceeds to step S126, wherein host 6 constructs and sends a DHCP decline packet over network 12, and thereafter at step S130 the process returns to step S102.

However, if the decision at step S119 is YES, then the process proceeds to step S120. At step S120, host 6 retrieves from the DHCP ACK packet the IP address for use by imaging apparatus 10 and the associated IP address lease time. Host 6 stores the IP address lease time in RAM in host processor 16. The process then proceeds to step S122.

At step S122, host 6 constructs a proprietary device IP configuration packet including the IP address retrieved from the DHCP ACK packet, and host 6 sends the device IP configuration packet to networking hardware 22 of imaging apparatus 10.

At step S124, it is determined whether the IP address was accepted by imaging apparatus 10. This determination can be made, for example, by sending a query packet using the IP address assigned to imaging apparatus, and awaiting a reply. If imaging apparatus 10 does not reply, then host 6 will assume that the IP address was not accepted.

If the determination at step S124 is NO, then at step S126 host 6 constructs and sends a DHCP decline packet over network 12, and thereafter the process returns to step S102. If the determination at step S124 is YES, then the process proceeds to step S128.

At step S128, host 6 executes software that monitors the IP address lease time on behalf of imaging apparatus 10. When the host software's lease algorithm indicates a new lease needs to be negotiated, i.e., the lease time is about to expire, host 6 negotiates the new lease time using the UAA of imaging apparatus 10, i.e., the MAC address of networking hardware 22, and using the IP address of host 6 in the “relay agent” field of the DHCP request packet. Thus, host 6 determines when to renegotiate the IP address to extend the lease of the IP address assigned to imaging apparatus 10. This lease renewal process, however, is transparent to imaging apparatus 10.

Following initiation of lease time monitoring at step S128, the process proceeds to step S130, and in turn the process returns to step S102.

Thus, the exemplary embodiment of the present invention as described herein provides a method that allows automatic negotiation of IP addresses for a non-host network-connected device, such as a peripheral device connected to a network via networking hardware, wherein the negotiation is conducted by a proxy IP address negotiator, such as host 6, rather than by the non-host based network-connected device itself.

It is contemplated that embodiments of the present invention may be implemented in a host, such as host 6, as either a primary automatic IP address negotiation utility for non-host network-connected devices, or as an optional or an auxiliary automatic IP address negotiation utility for non-host network-connected devices.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for negotiating a device IP address for a device connected to a network, comprising the steps of:
configuring a host computer connected to said network to serve as a proxy IP address negotiator;
said host computer constructing a first network packet for communicating with an IP address server connected to said network;
said host computer sending said first network packet over said network;
said IP address server responding to said host computer with a second network packet including a first IP address;
said host computer retrieving said first IP address from said second network packet; and
said host computer sending said first IP address to said device for adoption by said device as said device IP address.

2. The method of claim 1, wherein said first network packet includes a host IP address of said host computer and a universally administered address (UAA) of said device.

3. The method of claim 1, wherein said IP address server is a Dynamic Host Configuration Protocol (DHCP) server, and wherein said first network packet is a DHCP discover packet including a relay agent field, said host computer inserting a host IP address of said host computer in said relay agent field, and including a universally administered address (UAA) of said device.

4. The method of claim 3, wherein said host computer performs the step of retrieving said UAA of said device from said device.

5. The method of claim 4, wherein the retrieving step is effected by said host computer sending a proprietary discover packet on said network, said proprietary discover packet being received by said device and said device responding by sending said UAA of said device to said host computer.

6. The method of claim 1, wherein said host computer further performs the step of retrieving a lease time associated with said first IP address, and monitoring said lease time on behalf of said device.

7. The method of claim 1, wherein said device is networking hardware.

8. The method of claim 1, wherein said device is an imaging apparatus utilizing networking hardware to facilitate a connection to said network.

9. The method of claim 1, wherein said device adopts said first IP address as said device IP address.

10. The method of claim 1, wherein if said device does not adopt said first IP address as said device IP address, then said host computer performs the steps of:
constructing a decline packet; and
sending said decline packet to said IP address server to decline said first IP address.

11. A networked system, comprising:
a network;
a device connected to said network;
an IP address server connected to said network; and
a host connected to said network, said host having a host Internet Protocol (IP) address, said host negotiating a device IP address for said device by executing computer instructions for performing the steps of:
determining a universally administered address (UAA) of said device;
constructing a Dynamic Host Configuration Protocol (DHCP) discover packet, said host inserting said host IP address in a relay agent field of said DHCP discover packet, and including said UAA of said device;
sending said DHCP discover packet over said network;
retrieving a first IP address from said IP server; and
sending said first IP address to said device for adoption by said device as said device IP address.

12. The networked system of claim 11, wherein said host executes computer instructions for performing the further step of retrieving a lease time associated with said first IP address, and monitoring said lease time on behalf of said device.

13. The networked system of claim 11, wherein said device is networking hardware.

14. The networked system of claim 11, wherein said device is an imaging apparatus utilizing networking hardware to facilitate a connection to said network.

15. The networked system of claim 11, wherein said device adopts said first IP address as said device IP address.

16. The networked system of claim 11, wherein if said device does not adopt said first IP address as said device IP address, then said host performs the steps of:
constructing a decline packet; and
sending said decline packet to said IP address server to decline said first IP address.

17. A non-volatile memory configured with computer program instructions for loading on a host computer, said computer program instructions being adapted to configure said host computer to serve as a proxy IP address negotiator for negotiating a device IP address for a device connected to said network other than said host computer.

18. The non-volatile memory of claim 17, wherein said computer program instructions are adapted to configure said host computer for performing the steps of:
constructing a first network packet for communicating with an IP address server connected to said network;
sending said first network packet over said network;
retrieving a first IP address from a second network packet sent by said IP address server in response to said host computer; and
sending said first IP address over said network for adoption by said device as said device IP address.

19. The non-volatile memory of claim 17, wherein said first network packet includes a host IP address of said host computer and a universally administered address (UAA) of said device.

20. The non-volatile memory of claim 17, wherein said first network packet is a DHCP discover packet including a relay agent field, said computer program instructions being adapted to configure said host computer for performing the steps of inserting a host IP address of said host computer in said relay agent field, and including a universally administered address (UAA) of said device.

21. The non-volatile memory of claim 20, wherein said computer program instructions are adapted to configure said host computer for performing the step of retrieving said UAA from said device.

22. The non-volatile memory of claim 20, wherein said computer program instructions are adapted to configure said host computer for performing the steps of sending a proprietary discover packet on said network and retrieving said UAA from a response packet.

23. In a system including a device connected to a network, an IP address server connected to said network and a host connected to said network, said host having a host Internet Protocol (IP) address, a method for negotiating a device IP address for said device, wherein said host performs the steps of:
determining a universally administered address (UAA) of said device;
constructing a Dynamic Host Configuration Protocol (DHCP) discover packet by inserting said host IP address in a relay agent field of said DHCP discover packet, and by including said UAA of said device;
sending said DHCP discover packet over said network;
retrieving a first IP address from said IP address server; and
sending said first IP address to said device for adoption by said device as said device IP address.

24. The method of claim 23, wherein said host further performs the step of retrieving a lease time associated with said first IP address, and monitoring said lease time on behalf of said device.

25. The method of claim 23, wherein said device is networking hardware.

26. The method of claim 23, wherein said device is an imaging apparatus utilizing networking hardware to facilitate a connection to said network.

27. The method of claim 23, wherein said device adopts said first IP address as said device IP address.

28. The method of claim 23, wherein if said device does not adopt said first IP address as said device IP address, then said host performs the steps of:
constructing a decline packet; and
sending said decline packet to said IP address server to decline said first IP address.
